(19) United States
(12) Patent Application Publication
(10) Pub. No.: US 2013/0013176 A1
(43) Pub. Date: Jan. 10, 2013

(54) IDLE REDUCTION SYSTEM AND METHOD

(76) Inventor: Brian Bassindale, Ancaster (CA)

(21) Appl. No.: 13/533,215

(22) Filed: Jun. 26, 2012

Related U.S. Application Data
(60) Provisional application No. 61/504,272, filed on Jul. 4, 2011.

(51) Int. Cl. F02D 28/00

(52) U.S. Cl. 701/113; 701/102

(57) ABSTRACT

The present concept is method of controlling a vehicle's engine idle and includes the steps of monitoring a vehicles operating parameters with a controller and comparing parameters to preselected shutdown conditions. In the event shutdown conditions are met and the key is not in the ignition, the controller warns operator of impending shutdown. The controller intercepts the ignition key signal and simulates the vehicle key to be in the run position such that vehicle functions are operable as if key is in run position. The controller shuts down engine. The method may also include the steps of: the controller intercepting the ignition key signal and simulating the vehicle key to be in the accessory position such that vehicle functions are operable as if key is in accessory position.

This application claims priority from regularly filed U.S. provisional application No. 61/504,272 filed Jul. 4, 2011 by Brian Bassindale under the title idle reduction system and method.

### FIELD OF THE INVENTION

The present concept relates to idle management systems for automobiles, trucks and other commercial vehicles and more particularly relates to an idle reduction system and method of operation for motor vehicles including automobiles, trucks and other commercial vehicles.

### BACKGROUND OF THE INVENTION

Idling of motor vehicles contributes to the emission of greenhouse gases. In particular commercial and municipal vehicles are often left to idle for long periods of time due to the job responsibilities of the operator. In many instances the engine is left to idle in order to control temperature, communications and lighting equipment within the commercial and/or municipal vehicle.

For every liter of gas that is consumed approximately 2.54 kilograms of greenhouse gases is emitted into the atmosphere, Therefore there is a need for a system which will reduce the total idling time of vehicles and manage the idle time of vehicles.

### SUMMARY OF INVENTION

The present concept includes a method of controlling a vehicle's engine idle comprising the steps of:
a) Monitoring a vehicles operating parameters with a controller and compare parameters to preselected shutdown conditions;
b) in the event shutdown conditions are met and the key is not in the ignition, controller warns operator of impending shutdown;
c) controller intercepts the ignition key signal and simulates the vehicle key to be in the run position such that vehicle functions are operable as if key is in run position;
d) controller shuts down engine;

Preferably further including the steps of:
e) the controller intercepts the ignition key signal and simulates the vehicle key to be in the accessory position such that vehicle functions are operable as if key is in accessory position.

Preferably further including the steps of:
f) controller monitors cabin temperature;
g) controller comparing cabin temperatures to preselected start up conditions;
h) in the event start up conditions are met controller warns operator of impending start up;
i) controller intercepts the key signal and simulates the vehicle key to be in the run position such that all vehicle functions are operable as if key is in run position;
j) controller starts up engine
k) return to step a).

The method claimed in claim 1 wherein the vehicles operating parameters are received from the vehicle CAN BUS interface.

Preferably wherein the controller is a programmable logic controller communicating with the CAN BUS interface.

Preferably wherein the programmable logic controller intercepts signals coming from the ignition key and communicates signals to the vehicles on board computer simulating a preselected key position thereby enabling vehicle functions as if the vehicle was in that key position.

Preferably including the step of providing a controller interface communicating with the controller and displaying in real time the status of the vehicle to the operator.

Preferably wherein the controller interface is a high resolution screen communicating with the controller.

Preferably wherein the controller interface displays to the operator whether or not the vehicle engine is on.

Preferably wherein step b and c is replaced with the following steps:
b) in the event shutdown conditions are met and the key is in the ignition, controller warns operator of impending shutdown;
c) controller intercepts the key signal and simulates the vehicle key to be in the run position such that all vehicle functions are operable as if key is in run position;

Preferably further including the steps of:
e) Controller monitors cabin temperature;
f) Controller compares cabin temperatures to preselected start up conditions;
g) In the event start up conditions are met controller warns operator of impending start up;
h) Controller starts up engine;
i) Return to step a).

Preferably wherein the vehicles operating parameters are received from the vehicle CAN BUS interface.

Preferably wherein the controller is a programmable logic controller communicating with the CAN BUS interface.

Preferably wherein the programmable logic controller intercepts signals coming from the ignition key and communicates signals to the vehicles on board computer simulating a preselected key position thereby enabling vehicle functions as if the vehicle was in that key position.

Preferably further including the step of providing a controller interface communicating with the controller and displaying in real time the status of the vehicle to the operator.

Preferably wherein the controller interface is a high resolution screen communicating with the controller.

Preferably wherein the controller interface displays to the operator whether or not the vehicle engine is on.

### BRIEF DESCRIPTION OF THE DRAWINGS

The concept will now be described by way of example only with reference to the following drawings in which;

FIG. 1 is a flow chart entitled Shut Down Conditions showing a decision tree for engine shut down.

FIG. 2 is a flow chart entitled Heating and Cooling Example showing a decision tree for idle management to maintain heating and cooling functions within the vehicle.

FIG. 3 is a flow chart entitled Battery Monitoring Example showing a decision tree for maintaining battery condition.

FIG. 4 is a flow chart titled Hood Position Example showing a decision tree for opening the hood of a vehicle for maintenance.

FIG. 5 is a flow chart entitled Fan Function showing the decision tree in regard to operation of the fan.

### DETAILED DESCRIPTION OF THE PREFERRED EMBODIMENTS

### Definitions

As used in this specification the following terms refer to but are not limited to the following meanings:

“Vehicles operating parameters”—include but are not limited to vehicle speed, tachometer reading (rpm), vehicle gear (transmission position), cabin temperature, coolant temperature, air intake temperature, battery temperature and hood position

“Controller”—An aftermarket installed signal processor which preferably is a Programmable Logic Controller as described below which modifies routing of signals throughout the vehicle particularly receiving and intercepting the ignition key signal.

“Preselected shutdown conditions”—include but are not limited to a preselected vehicle speed, preselected engine's rotations per minute and preselected vehicle's transmission gear position.

“Ignition switch”—refers to the electronic switch which sends an ignition signal normally to the vehicle onboard computer

“Intercepts the ignition key signal”: in this concept the controller intercepts the ignition key signal rather than sending it to the vehicle onboard computer

The “ignition switch” generally has four positions: off position, accessories position, run position and start position

The “Run position” turns on all car's systems i.e. windshield wipers, window motors, etc.

The “Accessory position” normally allows certain car accessories such as the radio to be functional, however accessories that use too much battery power such as window motors remain off to prevent battery from being drained

“CAN BUS” interface refers to a “Controller-area network” which is a vehicle bus standard designed to allow microcontrollers and other devices to communicate with each other within a vehicle without a host computer.

Programmable logic controller (PLC): A device using programmed, custom instructions to provide automated monitoring and control functions by evaluating a set of inputs. Used to automate complex functions in a variety of applications.

### Description

The present concept an idle reduction system and method is designed to manage and reduce idling of motor vehicles and therefore the pollution and ultimately the amount of greenhouse gases that are emitted by a vehicle.

The idle reduction system and method consists of a high-resolution operator screen and a programmable logic controller (PLC) that is linked through the CAN BUS communications port that is present in almost every vehicle. The term CAN BUS stands for controller area network, which is a vehicle bus standard, designed to allow micro-controllers and devices to communicate with each other within a vehicle without a host computer.

The idle reduction system and method monitor's communications on the CAN BUS network to recognize and monitor a number of engine functions including but not limited to engine rpm, gear selector position, vehicle speed, coolant temperature, battery voltage, and other parameters.

The operator screen will provide information to the operator such as when the vehicle will start and when the vehicle will stop as well as a condition that will invoke the vehicle engine to start for example such as low voltage or the need for heating and cooling.

The operator screen will also provide means for the operator to set the desired temperature set point so that they will be kept comfortable while the engine remains off. The PLC will also record historical data and will save information that can later be viewed such as the number of hours that the idle reduction system and method was managing the engine and the reasons why it may have started the engine to provide feedback to the operator to maximize payback and minimize idling time.

The system is non-intrusive to the vehicle wiring by making only one connection to the OEM harness, which is present in almost every vehicle.

The idle reduction system and method will function in almost any type of mobile vehicle or equipment, which operates using a 12 or 24-volt electrical system.

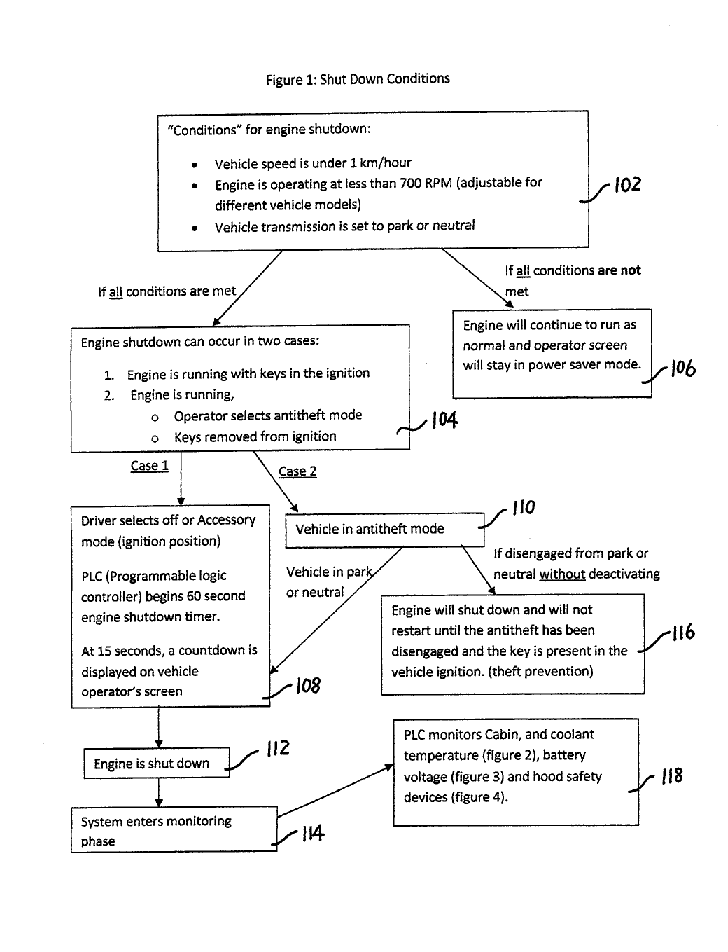

Referring now to FIG. 1 the idle reduction system and method controls shutdown of the engine as follows:

A PLC which is communicating through the CAN BUS network of the vehicle monitors transmission mode selection, engine rpm and the vehicle speed as shown as 102 in FIG. 1. When all three of these conditions are detected and acceptable the engine shutdown sequence can begin.

In the example given in FIG. 1 the vehicle speed must be under 1 kilometre per hour, the engine rpm must be less than 700, and the vehicles transmission must be set in park or neutral.

If all of these conditions are not met the engine will continue to run as shown as 106 in FIG. 1 and the PLC will remain in a power saver mode.

In the event that all of these conditions are met as shown as the programmable logic controller (PLC) begins to count in seconds wherein the default of 60 seconds being the time after which the engine will shut down. This count time is adjustable by the supervisor area. The operator screen will depict the last 15 seconds prior to engine shutdown in order to alert the operator that in 15 seconds time the engine will be shut down unless the operator intervenes. Therefore during the 60-second countdown period in the event that the three conditions met in 102 remain unchanged the engine will shutdown.

There are two distinct cases in which the engine is shut down, shown as 104 in FIG. 1.

In the first case the key is left in the ignition in either the accessory mode in which case windows, windshield wipers etc., would continue to operate to keep the windows clear and also other interior functions will continue to operate.

The keys may also be left in the off position to save power and not provide any of the above functionality.

The second case would be where the keys are removed from the ignition and the vehicle is placed in an anti-theft mode, which can be selected on the operator screen. This is shown as 110 in FIG. 1.

The operator selects the anti-theft mode 110 and removes the keys, when he or she leases the vehicle. The operator will typically secure the vehicle by locking all the doors and leave the vehicle in the running condition. The anti-theft device simulates the key being in the vehicle by using a module typically used by the OEM for a factory installed remote start. The PLC is able to teach the module the code that the vehicle computer requires by using the teach key portion in the installation portion of the screen. When anti-theft is selected a signal is sent to the vehicle computer through the CAN BUS wherein the vehicle thinks that the key is still installed. If at any time the transmission is moved from park the engine will shut down and will not restart until the anti-theft has been disengaged and the key is present in the vehicle ignition, which is shown as 116 in FIG. 1.

In the case where the engine is running with the keys in the ignition in this case the operator likely still is within the vehicle as shown as 108 in FIG. 1. Once the PLC completes its 60-second countdown, which includes a 15 second visual display countdown on the operator screen the engine is shut down 112 and the system enters a monitoring phase 114.

In the monitoring phase the PLC will monitor as shown as 118 in FIG. 1:

A) Cabin temperature, which is derived from a remotely installed sensor with the system.

B) Low voltage on the starting battery bank (Battery 1).

C) Low voltage on the auxiliary battery bank (Battery 2)

D) Coolant temperature from the vehicle CAN BUS.

E) Hood sensor safety, which is a magnetic sensor monitoring hood position for safety of technicians that may be servicing the vehicle.

Management of Heating and Cooling

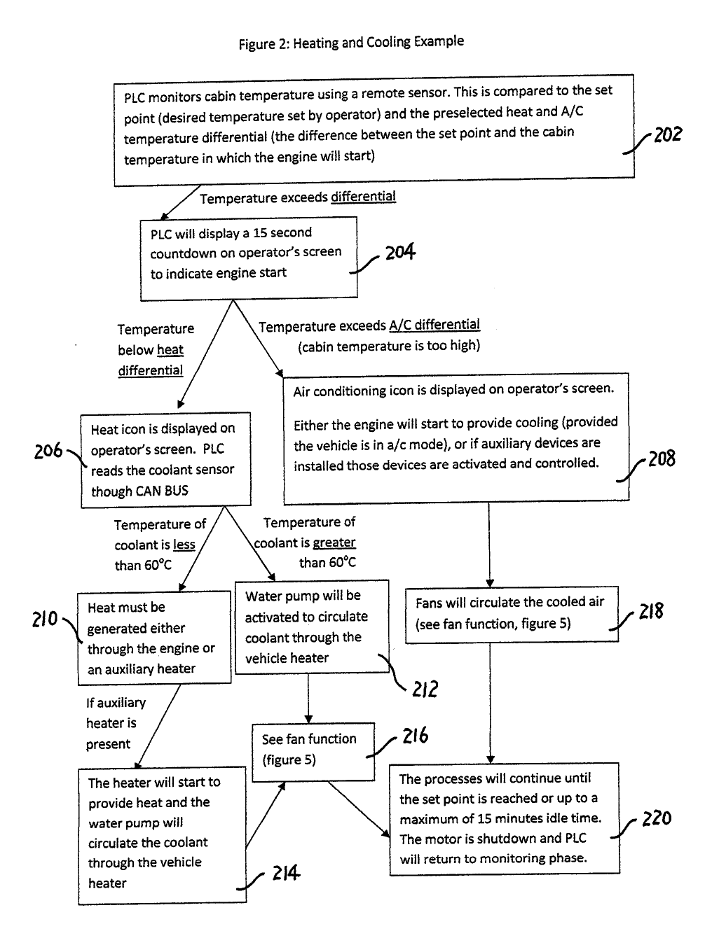

FIG. 2 is a flow chart showing an example of the idle reduction system and method managing heating and cooling in a vehicle.

Devices can be added to the vehicle in order to control the temperature such as: Fuel fired heaters which may heat the engine coolant and/or air type heaters, DC air conditioning systems to provide cooling and/or auxiliary power units to provide both heating and cooling.

An example of operations sequence is shown in FIG. 2.

The PLC is in the monitoring phase and monitors the cabin temperature using a remote sensor. This temperature is compared to a set point and a pre-selected heating and air conditioning temperature differential. For example the set point may be 20 degrees centigrade and the high temperature differential may be set at 10 degrees centigrade, a low temperature differential may be set at 3 degrees centigrade.

In this example the vehicles engine is used to cool the cabin compartment and in this example an auxiliary fuel fired heater is used to heat the engines coolant.

With the system in the monitoring phase shown as 202 the PLC detects an excessive temperature differential and will display a 15 second countdown on the operator screen to indicate that the engine will start shown as 204.

In the case of requirement for heating the temperature will be below the low temperature differential in this case 3 degrees below the set point of 20 and the heat icon is displayed on the operators screen and the PLC will read the coolant temperature of the sensor through the CAN BUS of the vehicle shown as 206.

In this example if the coolant temperature is less than 60 degrees centigrade heat must be generated either through the engine or through an auxiliary heater shown as 210.

In this case an auxiliary heater is present to heat the coolant of the engine and the heater will start to provide heat and the water pump will circulate the coolant through the vehicle heater shown in 214.

In the case where the temperature of the coolant is already greater than 60 degrees C. the water pump will be activated to circulate coolant through the vehicle heater and there will be no requirement for the auxiliary heater to be activated as shown as 212 in FIG. 2.

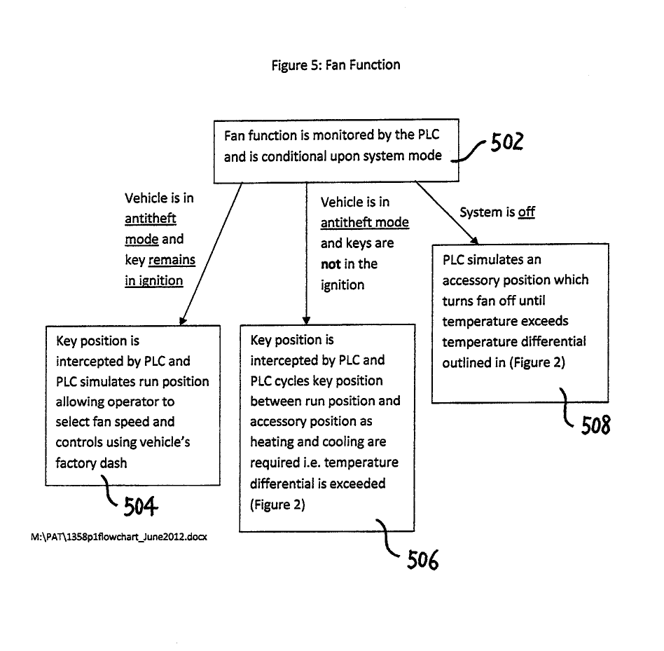

The fan function is activated as shown in 216 and explained more fully in FIG. 5 depending upon which mode the system is in. The process will continue until the set point is reached and the motor is shut down and the PLC will return to the monitoring phase 202.

In the case of air conditioning requirements in which case the cabin temperature is too high an air conditioning icon is displayed on the operators screen and either the engine will start to provide cooling if auxiliary devices are installed those devices are activated and controlled shown as 208 in FIG. 2.

Fans will circulate the cool air 218 which is more fully described and explained in FIG. 5 describing the fan function.

The engine will continue to run until the set point is reached or up to a maximum of 15 minutes of idle time. Thereafter the motor is shut down and the PLC will continue in the monitoring phase.

Battery Monitoring Example

Figure three shows an example of how the PLC can monitor the battery condition.

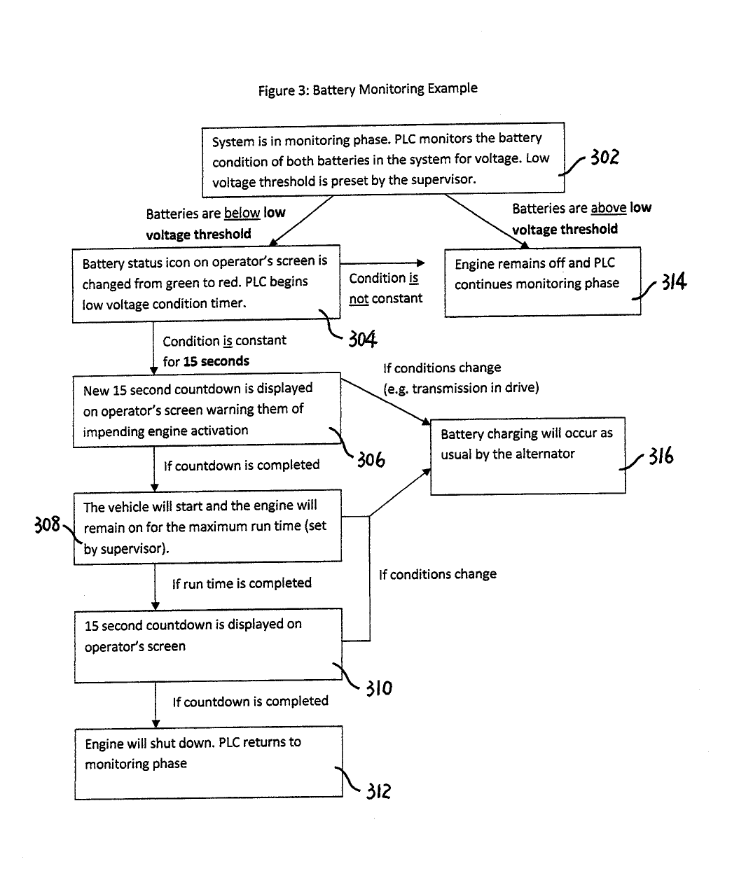

This example assumes that there are two batteries present. The original equipment battery denoted as battery 1 is the one used for starting the engine whereas battery 2 is used to run all the accessories in the vehicle including the computers. In this manner the threshold of the low voltage set point is normally higher for battery bank 1 for example 11.9 volts and the threshold for battery 2 is normally lower somewhere around 11.3 volts. The PLC monitors the battery condition of both batteries in the system for low voltage. The voltage threshold is preset by the supervisor and is shown as 302 in FIG. 3.

If the batteries are below the low voltage threshold then the battery status icon appears on the operators screen the PLC begins a low voltage condition timer. This is shown as 304 in FIG. 3.

Provided the condition is constant for at least 15 seconds, a new 15-second countdown is displayed on the operator screen warning them of an impending engine activation shown as 306 in FIG. 3.

Once the countdown is completed the vehicle engine will start and remain on for a maximum run time, which is normally set at 15 minutes shown as 308 in FIG. 3.

Once the run time is completed a 15 second countdown is again displayed on the operator screen as 310 and once the countdown is completed the engine will shut down shown as 312 and the PLC will return to the monitoring phase 302.

In this example battery charging will occur as usual by the normal alternator or generator, which is present in the engine shown as 316 in FIG. 3.

In the case where the batteries are above the low voltage thresholds the engine will remain off and the PLC will continue in the monitoring phase shown as 314.

Hood Position Example

Magnetic hood sensors are installed to ensure safety for technicians opening the hood for servicing the engine. If the engine is on and the hood is opened the engine will continue to run for inspection with automatic start/shut down disabled. If the hood is opened while the engine is off the engine will not automatically start. An LED is located in the sensor and will come on indicating to the technician that the engine is not going to automatically start.

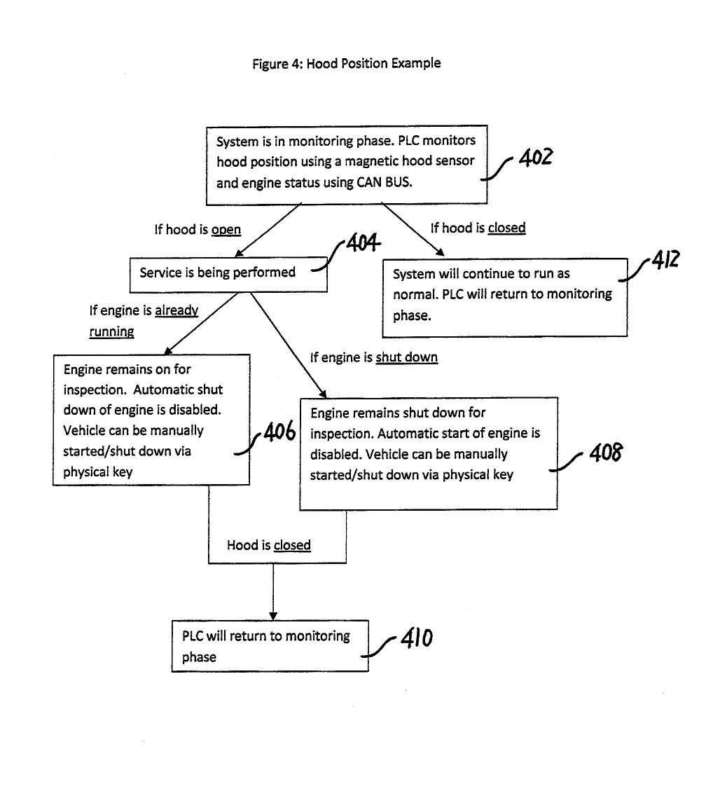

Referring to FIG. 4 with the system in the monitoring phase shown as 402 should the hood of a car be open shown as 404 and the engine is already running shown as 406 the engine will remain running for inspection with automatic shut down of engine disabled until the hood is closed shown as 412 and the system will return back to the monitoring phase shown as 410. On the other hand if the hood is open when the engine is turned off shown as 408 the automatic engine start will be disabled. In both cases when the hood is opened the vehicle can be manually started/shut down using the vehicles physical key.

Once the hood is closed the PLC will return to the monitoring phases shown as 410 and 402.

Fan Function

The fan in the vehicle will be controlled in three different ways. If the vehicle key remains in the ignition and anti-theft mode is selected the PLC intercepts and controls the key position such that the operator will have full control of the blower speed controls.

If the vehicle key remains in the ignition and anti-theft mode is selected the PLC determines whether temperature adjustment is required. The PLC simulates the key position to be in the Run position.

If the vehicle is left in the off position the PLC can be controlled such that the fan will come on to a predetermined position.

In the case that the vehicle is left in the anti-theft mode with keys remaining in the ignition shown as 504 the system is assuming that the operator is present in the vehicle and full control of all periphery features available when car is running (i.e. the blower, windshield wipers, etc) is retained by the operator.

In the case that the vehicle is left in the anti-theft mode with keys removed the ignition shown as 506 is assuming that the operator is not present in the vehicle and the blower is controlled by the PLC with fan intensity determined by factory dash setting.

FIG. 5 shows the fan function operations cycling the key position. With the PLC in the monitoring phase it will go to there are three different possibilities.

Firstly if the vehicle key remains in the ignition and antitheft mode is selected by the operator shown as 504 the PLC simulates the run position allowing the operator to select fan speed and controls using the vehicle's factory dash. If the vehicle key is removed from the ignition and anti-theft mode is selected shown as 506 the PLC simulates the accessory position which turns fan off until temperature exceeds temperature differential outlined in FIG. 2 blower intensity remains unchanged from operator's previous selection.

Lastly if the system is off meaning the key is in the off position the PLC simulates the accessory position which turns fan off until temperature exceeds temperature differential outlined in FIG. 2, blower intensity remains unchanged shown as 508 in FIG. 5.

It should be apparent to persons skilled in the arts that various modifications and adaptation of this structure described above are possible without departure from the spirit of the invention the scope of which defined in the appended claim.

1. A method of controlling a vehicle's engine idle comprising the steps of
a) monitoring a vehicles operating parameters with a controller and comparing parameters to preselected shutdown conditions;
b) in the event shutdown conditions are met and the key is not in the ignition, the controller warns the operator of an impending shutdown;
c) the controller intercepts the ignition key signal and simulates the vehicle key to be in the run position such that vehicle functions are operable as if the key is in run position;
d) the controller shuts down engine;

2. The method claimed in claim 1 further including the steps of:
e) the controller intercepts the ignition key signal and simulates the vehicle key to be in the accessory position such that vehicle functions are operable as if key is in accessory position.

3. The method claimed in claim 2 further including the steps of:
f) the controller monitors cabin temperature;
g) the controller comparing cabin temperatures to preselected start up conditions;
h) in the event start up conditions are met controller warns operator of impending start up;
i) the controller intercepts the key signal and simulates the vehicle key to be in the run position such that all vehicle functions are operable as if key is in run position;
j) controller starts up engine
k) return to step a).

4. The method claimed in claim 1 wherein the vehicles operating parameters are received from the vehicle CAN BUS interface.

5. The method claimed in claim 1 wherein the controller is a programmable logic controller communicating with the CAN BUS interface.

6. The method claimed in claim 5 wherein the programmable logic controller intercepts signals coming from the ignition key and communicates signals to the vehicles on board computer simulating a preselected key position thereby enabling vehicle functions as if the vehicle was in that key position.

7. The method claimed in claim 1 further including the step of providing a controller interface communicating with the controller and displaying in real time the status of the vehicle to the operator.

8. The method claimed in claim 7 wherein the controller interface is a high resolution screen communicating with the controller.

9. The method claimed in claim 7 wherein the controller interface displays to the operator whether or not the vehicle engine is on.

10. The method claimed in claim 1 wherein step b and c is replaced with the following steps:
b) in the event shutdown conditions are met and the key is in the ignition, controller warns operator of impending shutdown;
c) controller intercepts the key signal and simulates the vehicle key to be in the run position such that all vehicle functions are operable as if key is in run position;

11. The method claimed in claim 10 further including the steps of:
e) controller monitors cabin temperature;
f) controller compares cabin temperatures to preselected start up conditions;
g) in the event start up conditions are met controller warns operator of impending start up;
h) controller starts up engine;
i) return to step a).

12. The method claimed in claim 10 wherein the vehicles operating parameters are received from the vehicle CAN BUS interface.

13. The method claimed in claim 10 wherein the controller is a programmable logic controller communicating with the CAN BUS interface.

14. The method claimed in claim 13 wherein the programmable logic controller intercepts signals coming from the ignition key and communicates signals to the vehicles on board computer simulating a preselected key position thereby enabling vehicle functions as if the vehicle was in that key position.

15. The method claimed in claim 10 further including the step of providing a controller interface communicating with the controller and displaying in real time the status of the vehicle to the operator.

16. The method claimed in claim 15 wherein the controller interface is a high resolution screen communicating with the controller.

17. The method claimed in claim 15 wherein the controller interface displays to the operator whether or not the vehicle engine is on.
